(19) United States
(12) Patent Application Publication
(10) Pub. No.: US 2007/0245911 A1
(43) Pub. Date: Oct. 25, 2007

(54) Drive for a Rotary Printing Press

(75) Inventors: Roland Angert, Pfungstadt (DE); Jens Friedrichs, Neckargemund (DE); Christian Gorbing, Heidelberg (DE); Gerald Erik Hauptmann, Bammental (DE); Michael Kruger, Edingen-Neckarhausen (DE); Olaf Lorenz, Ludwigshafen (DE); Markus Mohringer, Weinheim (DE); Frank Schaum, Neckargemund (DE); Thomas Schmidt, Eppelheim (DE); Martin Seipel, Schriesheim (DE); Volker Weindel, Leutershausen (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/789,765

(22) Filed: Apr. 25, 2007

(30) Foreign Application Priority Data
Apr. 25, 2006 (DE) 10 2006 019 035.1

(51) Int. Cl. B41F 5/00

(52) U.S. Cl. 101/216

(57) ABSTRACT

A drive for a rotary printing press has a clutch with improved reliability in the main drive gear train. The drive has a gearwheel mechanism for transmitting a rotational movement of transfer drums during delivery of a printing material. The gearwheel mechanism includes a gearwheel pair with a driving gearwheel and a driven gearwheel and the driven gearwheel, which is arranged coaxially with respect to the driving gearwheel, is coupled during delivery to a shaft journal of a transfer drum. A clutch is provided for selectively producing and interrupting the transmission of torque between the driving gearwheel and the driven gearwheel. At least one motor is provided for feeding a torque into the gearwheel mechanism. A stepup gear mechanism is arranged in the torque flow between a clutch half of the clutch and a gearwheel.

### CROSS-REFERENCE TO RELATED APPLICATION

This application claims the priority, under 35 U.S.C. §119, of German patent application DE 10 2006 019 035.1, filed Apr. 25, 2006; the prior application is herewith incorporated by reference in its entirety.

### BACKGROUND OF THE INVENTION

### FIELD OF THE INVENTION

The invention lies in the printing technology field. More specifically, the invention relates to a drive for a rotary printing press, having a gearwheel mechanism for transmitting a rotational movement of transfer drums during delivery of a printing material, the gearwheel mechanism comprising a gearwheel pair having a driving gearwheel and a driven gearwheel and the driven gearwheel which is arranged coaxially with respect to the driving gearwheel being coupled during delivery to a shaft journal of a transfer drum, having a clutch for producing and interrupting the transmission of torque between the driving gearwheel and the driven gearwheel, and having at least one motor for injecting a torque into the gearwheel mechanism.

Sheet-fed printing presses having a plurality of printing units in an inline construction are known, in which the impression cylinders which convey sheets and the drums are driven by way of a gearwheel mechanism. The cylinders and drums are held rotatably in bearings in side walls by way of shaft journals. Gearwheels of the gearwheel mechanism are arranged fixedly in terms of rotation on the shaft journals. The gearwheels form a main drive gear train, into which a torque is fed by a motor during printing. The cylinders and drums have a defined rotary phase position during printing, with the result that the sheets which are held in grippers can be transferred in register from a cylinder or a drum to an adjacent drum which lies downstream or a cylinder.

Sheet-fed printing presses are known, the operating type of which can be set optionally to printing on only one side or to printing on both sides of the sheets. In order to set printing on both sides, a turning apparatus is set in operation in the conveying path of the sheets. The rotary phase positions of the cylinders and drums differ during printing on only one side and in perfecter operation. Commonly assigned German published patent application DE 42 23 189 A1 and its counter-part U.S. Pat. No. 5,398,606 describe an apparatus which makes it possible to divide the main drive gear train and to set the rotary phase of the cylinders and drums in front of the turning apparatus to the desired operating type with respect to the rotary phase position of the cylinders and drums after the turning apparatus. The apparatus comprises a clutch which can disconnect a gearwheel from the shaft journal of a turner drum. The clutch is configured as a friction clutch, friction faces of the disconnectable gearwheel and a gearwheel which is connected fixedly in terms of rotation to the shaft journal being pressed against one another during printing by means of a spring assembly. The disconnectable gearwheel and the gearwheel which is connected fixedly in terms of rotation to the shaft journal are permanently in engagement with the gearwheels of an adjacent storage drum and an impression cylinder.

The torques which can be transmitted in the main drive gear train are limited by the construction of the gearwheels, the connection to the shaft journals and by clutches. In particular, in the case of machines having a multiplicity of printing units and large sheet formats which are to be printed, static and dynamic torques occur which can lead to failure of the clutch. If the clutch fails, the rotary phase position of the printing units changes, with the result that printing errors are produced or, in the extreme case, grippers collide with drum elements.

It is possible to design a clutch of a turning apparatus of a sheet-fed printing press for a maximum torque which is to be transmitted. According to the commonly assigned published German patent application DE 102 02 386 A1 and its counter-part U.S. Pat. No. 6,695,114, a multiple disk clutch has been equipped both with friction elements and also with form-fitting elements. Clutches which are dimensioned in this way require a large amount of installation space which is not available in every case.

German patent DE 41 32 250 C2 (corresp. to U.S. Pat. No. 5,249,521) and German published patent application DE 198 43 066 A1 describe devices for changing over to recto printing or recto and verso printing on a sheet-fed printing press. In those devices the main drive gear train on a turner drum is divided by way of a clutch and phase setting is performed by way of an additional gear mechanism and an auxiliary drive. A planetary gearwheel mechanism, a bevel gearwheel mechanism or a differential gear mechanism serve as additional gear mechanism. The construction having an additional gear mechanism is expensive in terms of material and cost and requires a large amount of installation space.

### SUMMARY OF THE INVENTION

It is accordingly an object of the invention to provide a drive for a rotary printing press which overcomes the above-mentioned disadvantages of the heretofore-known devices and methods of this general type and which further improves the reliability of the clutch in the main drive gear train.

With the foregoing and other objects in view there is provided, in accordance with the invention, a drive for a rotary printing press, comprising:
a gearwheel mechanism for transmitting a rotational movement of transfer drums during delivery of a printing material, the gearwheel mechanism including a gearwheel pair with a driving gearwheel and a driven gearwheel, said driven gearwheel being disposed coaxially with respect to said driving gearwheel and being coupled to a shaft journal of a transfer drum during delivery of a printing material;
a clutch for producing and interrupting a transmission of torque between said driving gearwheel and said driven gearwheel, said clutch having a clutch half;
at least one motor for injecting a torque into said gearwheel mechanism; and
a stepup gear mechanism disposed within a torque flow between said clutch half and a respective said gearwheel.

In other words, the invention provides for a clutch for selectively closing or interrupting a transmission of torque between a driving and a driven gearwheel in the drive gear train of a sheet-fed printing press, with a stepup gear mechanism being arranged in the torque flow between a clutch half of the clutch and a gearwheel. In particular, coaxial gear mechanism types, such as planetary gearwheel mechanisms, cycloidal gear mechanisms or harmonic drive mechanisms, can be used as stepup gear mechanisms. In a sheet-fed printing press having a turning apparatus, the clutch can exist between double gears which are arranged coaxially with respect to a turner drum.

In comparison with the solutions according to the prior art, the torque which is to be transmitted by the clutch during printing is reduced, which is achieved by the transmission ratio of the stepup gear mechanism. In addition to the use of the transmission ratio, a plurality of clutches which act in parallel can be used. The elements of the drive can be arranged coaxially and within the circumferential contour of a double gearwheel, as a result of which a small amount of installation space is taken up.

In accordance with an added feature of the invention, the stepup gear mechanism is at least one planetary gearwheel mechanism.

In accordance with an additional feature of the invention, the driving gearwheel and said driven gearwheel are spur gears having an external toothing system with an equal radius, said driving gearwheel is rotatably mounted and said driven gearwheel is rotationally fixedly with said shaft journal; said driving gearwheel has an internal toothing system in addition to said external toothing system, and at least one planetary gear is in permanent engagement with said internal toothing and a sun gear that is rotatably mounted relative to said shaft journal; said planetary gear is mounted on a journal that is fixedly connected to said driven gearwheel in an axially parallel manner; and one said clutch half of said clutch is fixedly connected in terms of rotation to said planetary gear and another said clutch half is fixedly connected in terms of rotation and axially displaceably to a journal.

In accordance with another feature of the invention, the driving gearwheel is rotatably mounted and said sun gear is rotationally fixed on a shaft that is rotatably mounted with respect to said shaft journal. Preferably, the shaft can be coupled to an adjusting drive.

In accordance with a further feature of the invention, the driving gearwheel and said driven gearwheel are spur gears having an external toothing system with an equal radius; said driving gearwheel and said driven gearwheels are rotatably mounted on a shaft coaxially with respect to said shaft journal; said driven gearwheel has an internal toothing system in addition to said external toothing system, at least one planetary gear is in permanent engagement with said internal toothing system and a sun gear that is seated rotationally fixed on said shaft; said planetary gear is mounted on a journal fixedly connected to said driving gearwheel in an axially parallel manner; and one said clutch half of said clutch is fixedly connected in terms of rotation to said driving gearwheel and another said clutch half is fixedly connected in terms of rotation and axially displaceably to said shaft.

In accordance with a concomitant feature of the invention, the clutch is a force or friction clutch that can be actuated by a pressure medium.

Other features which are considered as characteristic for the invention are set forth in the appended claims.

Although the invention is illustrated and described herein as embodied in drive for a rotary printing press, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagram of a multi-color sheet-fed printing press having a turning apparatus;

FIG. 2 shows a planetary gearwheel mechanism and a clutch in the torque flow between double gearwheels on a turner drum;

FIG. 3 shows a planetary gearwheel mechanism and a clutch between double gearwheels with a possibility for phase adjustment on a sun gear;

FIGS. 4 and 5 show pneumatic actuating apparatuses for a clutch between double gearwheels; and

FIG. 6 shows a planetary gear mechanism and a clutch between a planetary gearwheel carrier and a sun gear.

### DETAILED DESCRIPTION OF THE INVENTION

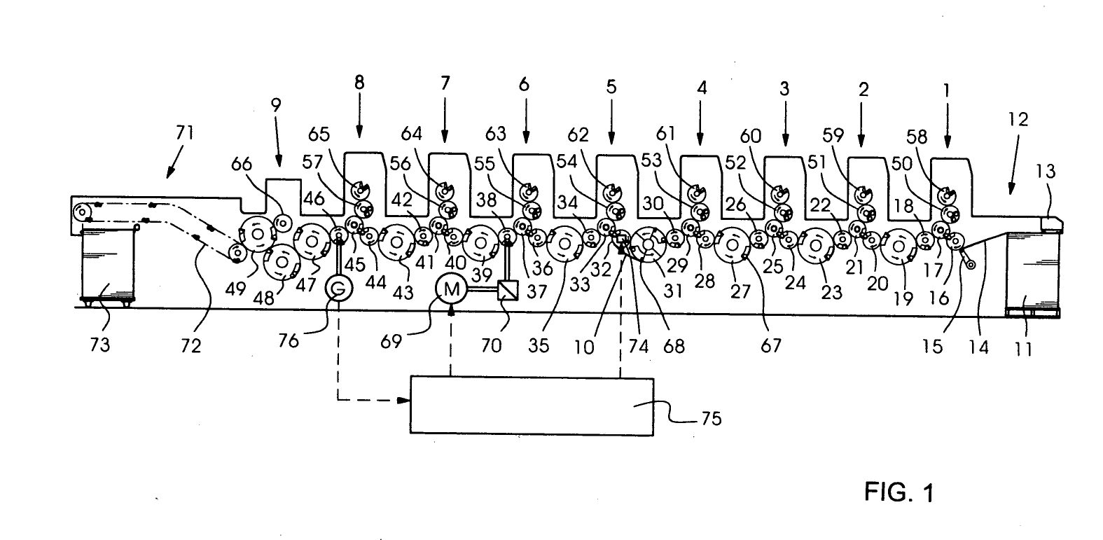

Referring now to the Figures of the drawing in detail and first, particularly, to FIG. 1 thereof, there is shown a perfector printing press having eight printing units 1-8 and a varnishing unit 9 for printing on sheets 10. In order to separate sheets 10 from a stack 11 and in order to convey them to the first printing unit 1, there is provided a feeder 12 having a suction head 13, a creeper table 14, and swinging grippers 15. In order to convey the sheets 10 through the printing press, transfer drums 16-49 are provided. The transfer drums 17, 21, 25, 29, 33, 37, 41, 45, 49 are configured as impression cylinders and interact with transfer cylinders 50-57. The transfer cylinders 50-57 interact with form cylinders 58-65. In the varnishing unit, the transfer drum 49 interacts directly with a form cylinder 66. During the passage through a press nip between a transfer cylinder 50 to 57 and an impression cylinder 17, 21, 25, 29, 37, 41, 45, 49, the sheets 10 are printed with a separated color. The separated color of a color separation is transferred by the respective form cylinder 58-65 onto a transfer cylinder 50-57. The color separation is transferred by the respective transfer cylinder 50-57 onto a surface of a sheet 10. In the varnishing unit, the sheets 10 are given in each case one terminating varnish coat on that side of a sheet 10 which was printed last. All transfer drums 16-49 which guide sheets 10 have gripper arrangements 67 for holding the sheets 10 at the front edge. The transfer drum 31 has additional gripper arrangements 68 for holding a sheet 10 at the rear edge. The transfer drums 16-49, the transfer cylinders 50-57 and the form cylinders 58-66 are coupled to one another in a gearwheel mechanism. In order to drive the printing press, a motor 69 is provided which feeds a torque onto the shaft of the transfer drum 38 via a gear mechanism 70. The sheets 10 which have been completely printed are conveyed onto a stack 73 in a delivery 71 by way of a chain gripper system 72.

The printing press can be changed over from printing on only one side of the sheets 10 to printing on both sides. In perfector operation, the printing units 1-4 serve to print onto the front side and the printing units 5-8 and the varnishing unit 9 serve to print onto the rear side of the sheets 10. Between the printing units 4 and 5, the transfer drums 31, 32 are configured as storage drum and turner drum. During printing on both sides, the phase positions of the gripper arrangements 67, 68 are set in such a way that the edge which trails in the printing units 1-4 is conveyed further as front edge from the printing unit 5. In order to set the phase position, a clutch arrangement 74 which permits division of the gearwheel train of the gearwheel mechanism is provided at the turner drum 32.

The remote control clutch arrangement 74 is connected to a control device 75. The phase setting is performed by way of the motor 69 or an additional adjusting motor on the transfer drum 31 and is monitored by way of a rotary encoder G on the shaft of the transfer drum 46 or the shaft of the transfer drum 17. That part in the drive train which is not moved in each case during the phase setting is fixed so as not to rotate. The rotary encoder 76 and the motor 69 are likewise connected to the control device 75.

During printing operation, the clutch arrangement 74 is closed, with the result that, starting from the motor 69 via the clutch arrangement 74, a torque is transmitted to the elements which are to be driven in the printing units 1-4.

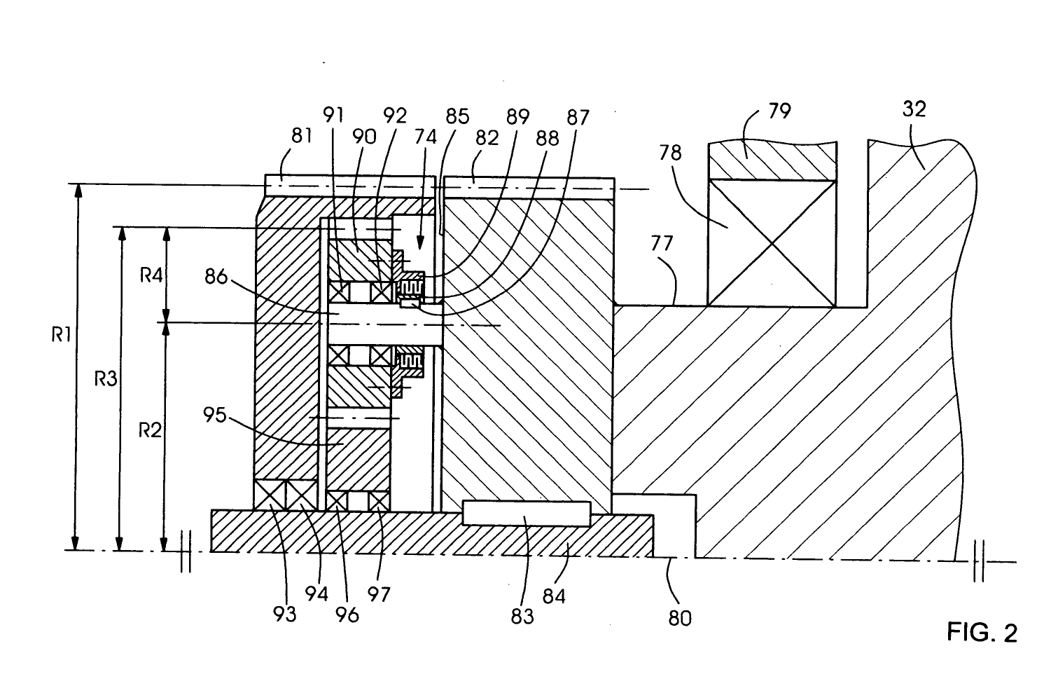

In the following text, exemplary embodiments for clutch arrangements 74 are to be described using FIGS. 2 to 6. If designations which have already been introduced are used in the following description, they relate to elements with an equivalent function.

FIG. 2 shows, in a section transversely through the printing unit 5, the turner drum 32 which is held by way of a shaft journal 77 in a bearing 78 of a side wall 79 of the sheet-fed printing press, such that it can rotate about the shaft axle 80. Gearwheels 81, 82 which are arranged coaxially with respect to the axle 80 and have the same radius R1 serve to drive the turner drum 32. The gearwheel 82 is connected fixedly to the shaft journal 77. The gearwheel 82 is coupled by means of a spring 83 to a shaft 84 which is arranged coaxially with respect to the axle 80. Journals 86 are fastened to that end face 85 of the gearwheel 82 which faces the gearwheel 81, at a spacing R2 from and parallel to the axle 80. A first half 88 of the clutch 77 is arranged fixedly in terms of rotation on each journal 86 by way of a spring 87. A second half 89 of the clutch 74 is connected to a planetary gear 90 which is held rotatably in bearings 91, 92 on the journal 86. In addition to an external toothing system on the radius R1, the gearwheel 81 has an internal toothing system on a radius R3. The gearwheel 81 is arranged rotatably in bearings 93, 94 on the shaft 84. The external toothing system of the planetary gear 90 is in engagement with the internal toothing system of the gearwheel 81. Furthermore, the planetary gear 90 is in engagement with a sun gear 95 which is arranged rotatably in bearings 96, 97 on the shaft 84.

The planetary gear 90 can be connected rigidly in terms of rotation to the journal 86 in each case by way of a clutch 74. This affords the advantage that the torque which is to be transmitted at the clutch 74 is additionally reduced in a multiplied manner by the transmission ratio in the planetary gearwheel mechanism and by the number n of planetary gears 90. The torque M_{K} which acts at the clutch 74 results from
n*M_{K}=Mₛₑₜₚ*R4/R2,
wherein Mₛₑₜₚ is the overall torque which is to be transmitted and R4 is the radius of the planetary gear 90. The smaller the radius R4 of a planetary gear 90 is designed to be, the lower the torque which is to be transmitted via a clutch 74.

In printing operation, the clutches 74 are closed, with the result that there is a rotatable connection between the gearwheels 81, 82 without a transmission ratio. In order to set the phase position, the clutches 74 are released and the driven gearwheel 82 or a gearwheel which is connected to the gearwheel 82 is fixed in position. The rotary position of the driving gearwheel 81 and the elements which are connected to it can therefore be adjusted in an infinitely variable manner relative to the driven gearwheel 82.

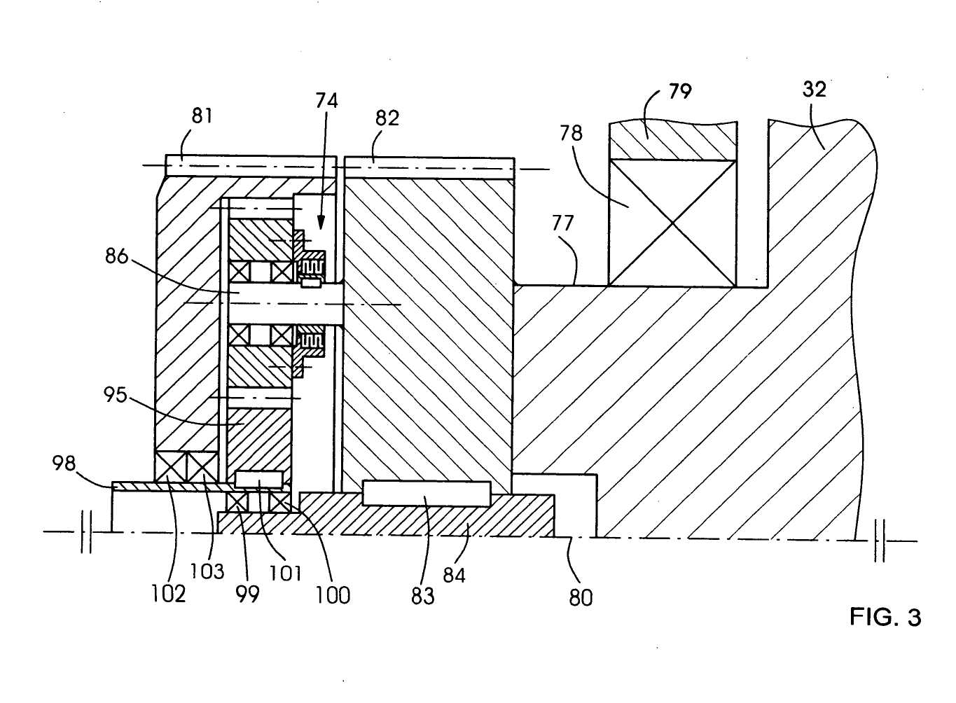

In one variant according to FIG. 3, the driving gearwheel 81 and the sun gear 95 are arranged coaxially with respect to a sleeve 98 which is held rotatably in bearings 99, 100 on a shoulder of the shaft 84. The sun gear 95 is connected fixedly in terms of rotation to the sleeve 98 by means of a spring 101. The gearwheel 81 is arranged rotatably on the sleeve 98 by way of bearings 102,103. All further details correspond to the details which are described with respect to FIG. 2.

In order to adjust the phase of the gearwheel 81 including the elements which are connected to it, the sleeve 98 can be coupled to a drive. If the sleeve 98 is rotated about the axle 80 when the clutches 74 are open, the sun gear 95 is corotated and a transmission ratio i=1+Z_{I}/Z_{S} acts on the gearwheel 82, wherein Z_{I} and Z_{S} are in each case the number of teeth of the internal toothing system of the gearwheel 81 and that of the sun gear 95. The transmission ratio i reduces the required adjusting moment and increases the sensitivity of the changeover.

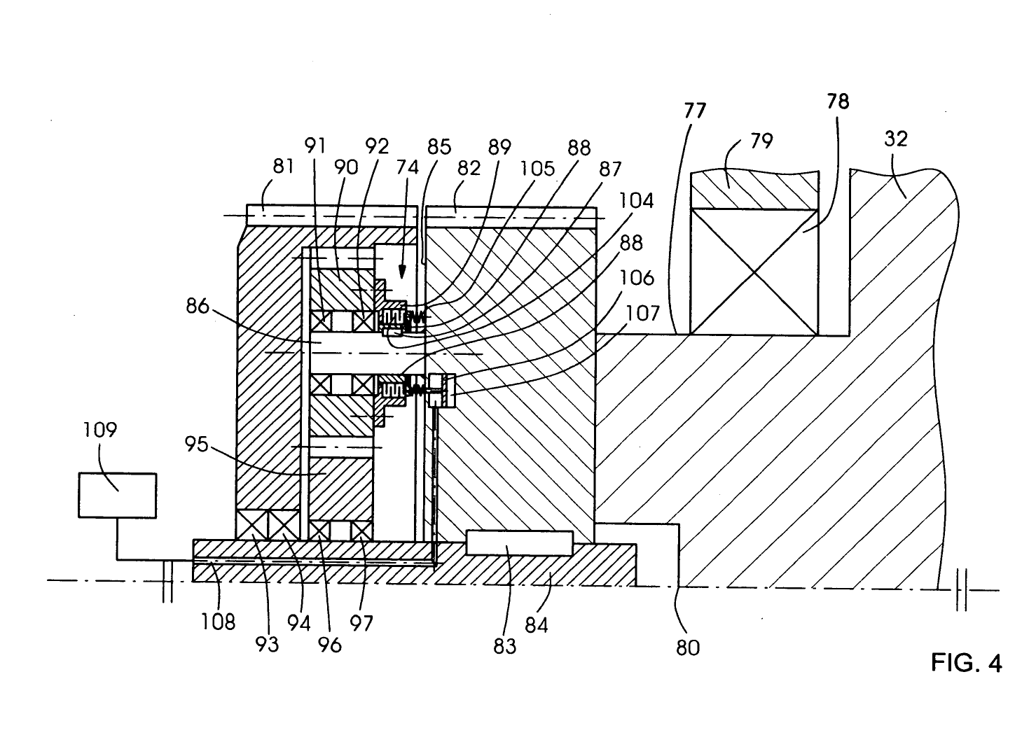

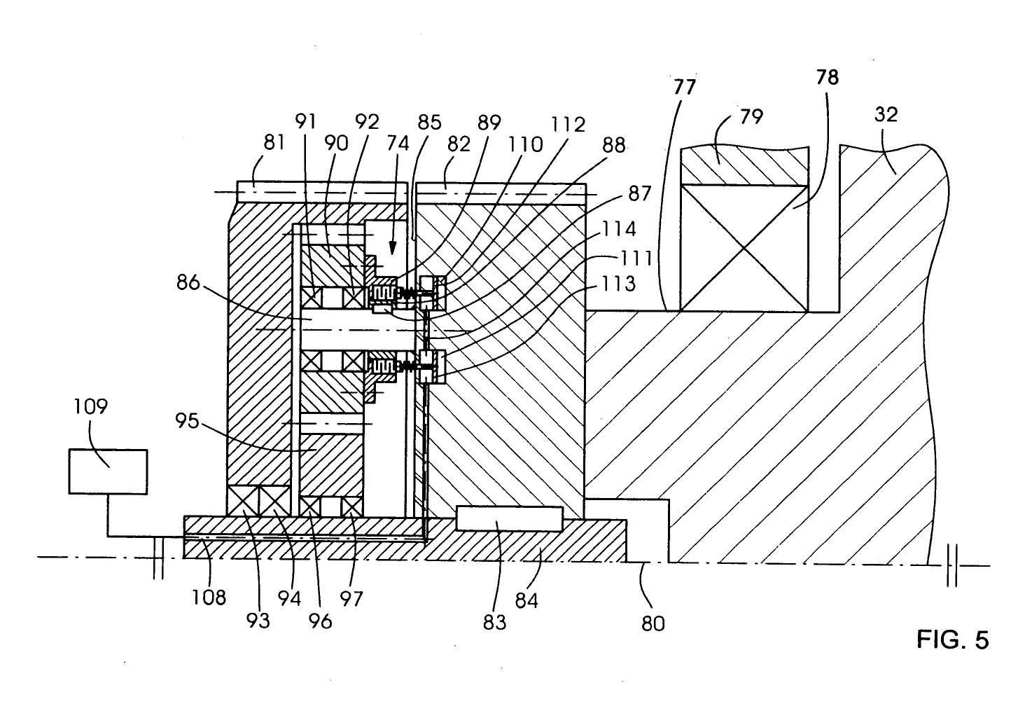

FIGS. 4 and 5 show various possibilities for actuating the clutch 74. The clutches 74 are configured as friction clutches having disks 104. During printing, the clutches 74 are closed by means of spring elements 105 in an operationally reliable manner. In order to release the clutches 74, pneumatic elements, by way of example, are provided. As an alternative, hydraulic elements can also be used to release the clutches.

According to FIG. 4, the clutch halves 88 of the clutches 74 are coupled to an annular piston 106. The annular piston 106 interacts with a working cylinder 107. A ventilation bore 108 leads radially and in the direction of the axle 80 through the gearwheel 82 and the shaft 84 from the working cylinder 107. The ventilation bore 108 leads to a compressed air unit 109. During phase setting, all actuating elements of the clutches 74 are situated in fixed parts in the drive gear train, as a result of which the clutch halves 88, 89 can be released from one another from outside by way of the working cylinder 107 being loaded with pressure.

In the variant according to FIG. 5, a working cylinder 110, 111 having a piston 112, 113 is assigned to each clutch 74 for actuation. The working cylinders 110, 111 are connected to a common line 114. The actuating energy is fed to the working cylinders 110, 111 from a compressed air unit 109 via a ventilation bore 108. The pistons 112, 113 are coupled in each case to the clutch half 88 which is arranged fixedly in terms of rotation on the journal 86.

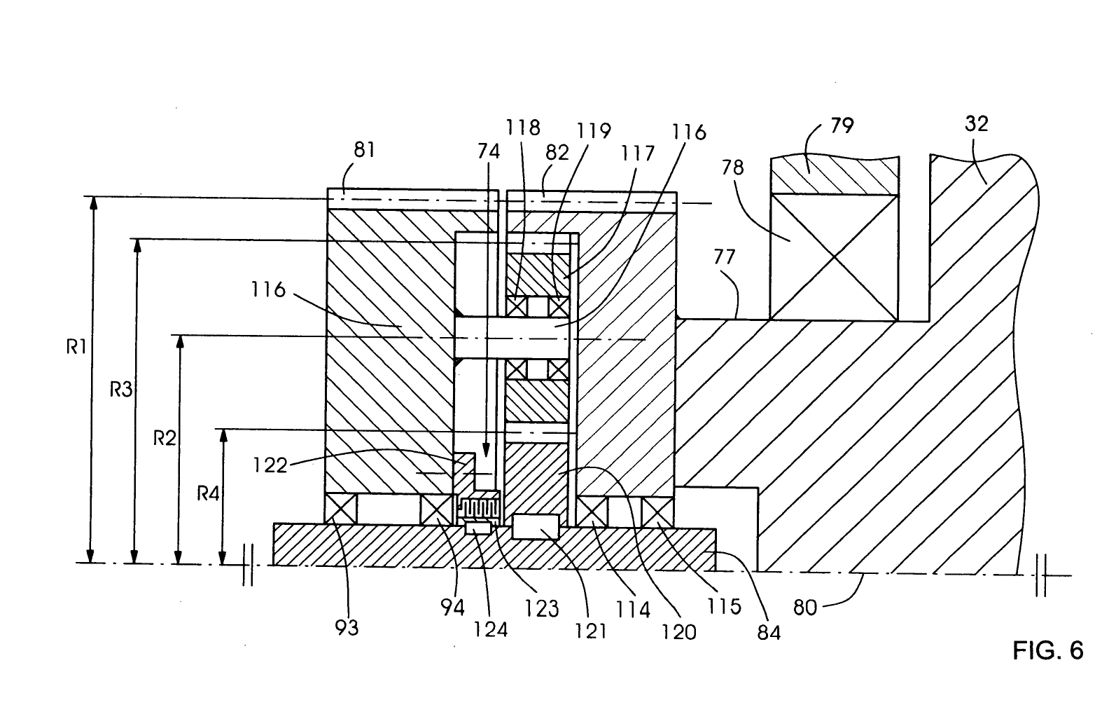

FIG. 6 shows a further variant for a drive of a sheet-fed rotary printing press. A driven gearwheel 82 of a turner drum 32 is held by way of bearings 114, 115 rotatably on a shaft 84 which is arranged coaxially with respect to the axle 80 of the turner drum 32. Furthermore, a second gearwheel 81 is held rotatably on the shaft 84 by way of bearings 93, 94. The gearwheels 81, 82 have the same radius R1. Journals 116 which lie parallel to the axle 80 are fastened to the gearwheel 81 at a spacing R2. The journals 116 carry planetary gears 117 which are rotatable by way of bearings 118, 119. The gearwheel 82 has an internal toothing system with the radius R3. The planetary gears 117 are in engagement with the internal toothing system and a sun gear 120 with the radius R4. The sun gear 120 is connected fixedly in terms of rotation to the shaft 84 by way of a spring 121. A half 122 of the multiple disk clutch 74 is fastened on that side of the gearwheel 81 which faces the gearwheel 82. The associated second half 123 is arranged fixedly in terms of rotation on the shaft 84 by way of a spring 124.

During printing, the clutch 74 is closed, with the result that the gearwheel 81 is connected rigidly in terms of rotation to the sun gear 120. A torque M_{K} acts on the clutch 74 as a result of a transmission ratio in the planetary gearwheel mechanism, where
M_{K}=Mₛₑₜₚ*R4/R3.

Mₛₑₜₚ is the torque which is fed by the driving gearwheel 81 from the drive gear train. The smaller the radius R4 of the sun gear 120 is selected to be, the lower the torque M_{K} which is to be transmitted.

During the setting of the phase of the turning apparatus, the clutch 74 is released and the gearwheel 82 and the elements which are connected to it in the drive gear train are fixed in position. The gearwheel 81 and the elements of the drive gear train which are connected to it can therefore be adjusted relative to the gearwheel 82 in an infinitely variable manner by way of the motor 89 or an auxiliary motor.

As an alternative to the adjustment on the side of the gearwheel 81, an adjustment can take place by rotation of the sun gear 120. Here, a transmission ratio i is active, where
i=1+Z_{I}/Z_{S},
wherein Z_{I} and Z_{S} are the numbers of teeth of the internal toothing system of the gearwheel 82 and of the sun gear 120. The transmission ratio i reduces the required adjusting torque and increases the sensitivity of the changeover. If an adjustment is provided on the sun gear 120, a form-fitting clutch 74 is also possible because, as a result of the transmission ratio i, a sufficiently high rotary angle resolution is ensured for an adjustment of the turning apparatus to a defined sheet format.

1. A drive for a rotary printing press, comprising:
a gearwheel mechanism for transmitting a rotational movement of transfer drums during delivery of a printing material, the gearwheel mechanism including a gearwheel pair with a driving gearwheel and a driven gearwheel, said driven gearwheel being disposed coaxially with respect to said driving gearwheel and being coupled to a shaft journal of a transfer drum during delivery of a printing material;
a clutch for producing and interrupting a transmission of torque between said driving gearwheel and said driven gearwheel, said clutch having a clutch half;
at least one motor for injecting a torque into said gearwheel mechanism; and
a stepup gear mechanism disposed within a torque flow between said clutch half and a respective said gearwheel.

2. The drive according to claim 1, wherein said stepup gear mechanism is at least one planetary gearwheel mechanism.

3. The drive according to claim 1, wherein:
said driving gearwheel and said driven gearwheel are spur gears having an external toothing system with an equal radius, said driving gearwheel is rotatably mounted and said driven gearwheel is rotationally fixedly with said shaft journal;
said driving gearwheel has an internal toothing system in addition to said external toothing system, and at least one planetary gear is in permanent engagement with said internal toothing and a sun gear that is rotatably mounted relative to said shaft journal;
said planetary gear is mounted on a journal that is fixedly connected to said driven gearwheel in an axially parallel manner; and
one said clutch half of said clutch is fixedly connected in terms of rotation to said planetary gear and another said clutch half is fixedly connected in terms of rotation and axially displaceably to a journal.

4. The drive according to claim 3, wherein said driving gearwheel is rotatably mounted and said sun gear is rotationally fixed on a shaft that is rotatably mounted with respect to said shaft journal.

5. The drive according to claim 4, wherein said shaft is configured for coupling to an adjusting drive.

6. The drive according to claim 1, wherein:
said driving gearwheel and said driven gearwheel are spur gears having an external toothing system with an equal radius;
said driving gearwheel and said driven gearwheels are rotatably mounted on a shaft coaxially with respect to said shaft journal;
said driven gearwheel has an internal toothing system in addition to said external toothing system, at least one planetary gear is in permanent engagement with said internal toothing system and a sun gear that is seated rotationally fixed on said shaft;
said planetary gear is mounted on a journal fixedly connected to said driving gearwheel in an axially parallel manner; and
one said clutch half of said clutch is fixedly connected in terms of rotation to said driving gearwheel and another said clutch half is fixedly connected in terms of rotation and axially displaceably to said shaft.

7. The drive according to claim 1, wherein said clutch is a force or friction clutch configured for actuation by a pressure medium.
